(19) United States
(12) Patent Application Publication
(10) Pub. No.: US 2021/0064231 A1
(43) Pub. Date: Mar. 4, 2021

(54) SYSTEM, METHOD AND USER-INTERACTION CONSOLE FOR CONTROLLING AT LEAST ONE SOFTWARE APPLICATION

(71) Applicant: LoupeDeck Oy, Helsinki (FI)

(72) Inventors: Pauli Seppinen, Vantaa (FI); Karo Holmberg, Helsinki (FI); Vasily Balagurov, Salo (FI); Jussi Mäkinen, Espoo (FI); Ville Rahikka, Nurmijärvi (FI); Pauli Immonen, Hyvinkää (FI)

(21) Appl. No.: 16/556,275

(22) Filed: Aug. 30, 2019

(51) Int. Cl. G06F 3/0488; G06F 3/14; G06F 3/0484; G06F 3/16; G06F 3/0362; G06F 3/02; G06F 3/0481

(52) U.S. Cl. CPC G06F 3/04886; G06F 3/1423; G06F 3/04847; G06F 3/04817; G06F 3/0362; G06F 3/02; G06F 3/167

(57) ABSTRACT

A system, method and a user-interaction console for controlling at least one software application includes at least one user-interaction console and a processor coupled in communication with the at least one user-interaction console. The user-interaction console includes a plurality of physical user-interaction controllers, wherein a given physical user-interaction controller is associated with at least one context-based command pertaining to the at least one software application; a first touch-sensitive display; and a mechanical grid frame arranged on top of at least a portion of the first touch-sensitive display, wherein the mechanical grid frame defines a plurality of sub-portions in at least a portion of the first touch-sensitive display.

### TECHNICAL FIELD

The present disclosure relates generally to software application control; and more specifically, to systems for controlling at least one software application. Moreover, the present disclosure relates to methods for controlling at least one software application. Furthermore, the present disclosure also relates to user-interaction consoles for controlling at least one software application.

### BACKGROUND

With advancements in digital technology, a multitude of tasks conventionally performed manually have been delegated to computing devices. With developments in software applications that are executed on such computing devices, said software applications can perform a wide variety of task with ease. Notably, such software applications comprise a plurality of operations therein that a user can perform to achieve a completion of the task. For example, in a software application for performing a task of image editing, the user may perform operations such as adjustments related to size, brightness, sharpness, contrast and the like to achieve an edited image of preferences desired by the user. In particular, in order to provide commands relating to the plurality of operations, the user generally employs input devices associated with said computing devices executing the software application.

Conventionally, computing devices have input devices such as keyboard, mouse, joysticks and so forth, associated therewith. Generally, the mouse associated with a computing device is employed to perform operations such as selection of functions in software applications, adjust values related to parameters of the software applications and so forth. Specifically, the user may use the mouse to navigate through the software application to perform operation therein. However, using the mouse as an input device involves navigation through multiple menus and sub-menus therein to accomplish the desired operation.

Recently, advanced software applications for performing sophisticated and complex tasks comprise hundreds of operations therein. The users of such advanced software applications may employ such operations according to their requirements and preferences. However, due to the such high number of operations available to the user, using the software application to perform the task efficiently becomes difficult. Although such advanced software applications have the availability of in-built and customizable keyboard shortcuts for performing different functions, efficiently utilizing such keyboard shortcuts to perform the desired task requires comprehensive knowledge of the software applications, and the required syntaxes or combinations. Consequently, a user without such comprehensive knowledge may not be able to perform the task efficiently thus substantially limiting the scope thereof.

In recent times, hardware consoles specific to software applications have been developed. However, for hardware consoles specific to advanced software applications, the number of user-interaction controllers thereon is too high for a user to operate efficiently. Furthermore, a user may use touch-sensitive display of the computing device executing the software application. However, such touch-sensitive displays do not provide the user with tactile feedback to the selected control, and the user needs to continuously see the screen when using it.

Therefore, in light of the foregoing discussion, there exists a need to overcome the aforementioned drawbacks associated with the existing systems for controlling software applications.

### SUMMARY

The present disclosure seeks to provide a system for controlling at least one software application. The present disclosure also seeks to provide a method for controlling at least one software application. The present disclosure also seeks to provide a user-interaction console for controlling at least one

The present disclosure seeks to provide a solution to the existing problem of inefficient and time-consuming modes of controlling software applications. An aim of the present disclosure is to provide a solution that overcomes at least partially the problems encountered in prior art, and provides simplified, customizable solution for controlling software applications.

In one aspect, an embodiment of the present disclosure provides a system for controlling at least one software application, the system comprising:
at least one user-interaction console, the user-interaction console comprising:
a plurality of physical user-interaction controllers, wherein a given physical user-interaction controller is associated with at least one context-based command pertaining to the at least one software application;
a first touch-sensitive display that, in operation, displays a first graphical information; and
a mechanical grid frame arranged on top of at least a portion of the first touch-sensitive display, wherein the mechanical grid frame defines a plurality of sub-portions in said portion of the first touch-sensitive display; and
a processor coupled in communication with the at least one user-interaction console, wherein the processor is configured to execute a service software application to:
   obtain contextual information pertaining to the at least one software application;
   configure the at least one user-interaction console, based on the contextual information, to establish compatibility between the at least one user-interaction console and the at least one software application;
   display the first graphical information at the first touch-sensitive display;
   enable, via the at least one user-interaction console, a user to provide the at least one context-based command;
   convert the at least one context-based command into a required format that is understandable by the at least one software application; and
   transmit the at least one context-based command having the required format to the at least one software application to control the at least one software application.

In another aspect, an embodiment of the present disclosure provides a method for controlling at least one software application via at least one user-interaction console, the user-interaction console comprising a plurality of physical user-interaction controllers, a first touch-sensitive display, and a mechanical grid frame arranged on top of at least a portion of the first touch-sensitive display, the method comprising:
obtaining contextual information pertaining to the at least one software application;
configuring the at least one user-interaction console, based on the contextual information, to establish compatibility between the at least one user-interaction console and the at least one software application;
displaying the first graphical information at the first touch-sensitive display;
enabling, via the at least one user-interaction console, a user to provide the at least one context-based command;
converting the at least one context-based command into a required format that is understandable by the at least one software application; and
transmitting the at least one context-based command having the required format to the at least one software application to control the at least one software application.

In yet another aspect, an embodiment of the present disclosure provides user-interaction console for controlling at least one software application, the user-interaction console comprising:
a plurality of physical user-interaction controllers, wherein a given physical user-interaction controller is associated with at least one context-based command pertaining to the at least one software application;
a first touch-sensitive display that, in operation, displays a first graphical information; and
mechanical grid frame arranged on top of at least a portion of the first touch-sensitive display, wherein the mechanical grid frame defines a plurality of sub-portions in said portion of the first touch-sensitive display.

Embodiments of the present disclosure substantially eliminate or at least partially address the aforementioned problems in the prior art, and enable a user to conveniently control the at least one software application.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIGS. 1 and 2 illustrate block diagrams of architectures of a system for controlling at least one software application, in accordance with different embodiments of the present disclosure;

FIG. 3 illustrates a schematic diagram of a user-interaction console for controlling at least one software application, in accordance with an embodiment of the present disclosure;

FIGS. 4A and 4B collectively illustrate steps of a method for controlling at least one software application via at least one user-interaction console, in accordance with an embodiment of the present disclosure; and

FIGS. 5A and 5B illustrate example of arranging a mechanical grid frame in top of a first touch sensitive display in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a system for controlling at least one software application, the system comprising:
at least one user-interaction console, the user-interaction console comprising:
a plurality of physical user-interaction controllers, wherein a given physical user-interaction controller is associated with at least one context-based command pertaining to the at least one software application;
a first touch-sensitive display that, in operation, displays a first graphical information; and
a mechanical grid frame arranged on top of at least a portion of the first touch-sensitive display, wherein the mechanical grid frame defines a plurality of sub-portions in said portion of the first touch-sensitive display; and
a processor coupled in communication with the at least one user-interaction console, wherein the processor is configured to execute a service software application to:
   obtain contextual information pertaining to the at least one software application;
   configure the at least one user-interaction console, based on the contextual information, to establish compatibility between the at least one user-interaction console and the at least one software application;
   display the first graphical information at the first touch-sensitive display;
   enable, via the at least one user-interaction console, a user to provide the at least one context-based command;
   convert the at least one context-based command into a required format that is understandable by the at least one software application; and
   transmit the at least one context-based command having the required format to the at least one software application to control the at least one software application.

In another aspect, an embodiment of the present disclosure provides a method for controlling at least one software application via at least one user-interaction console, the user-interaction console comprising a plurality of physical user-interaction controllers, a first touch-sensitive display, and a mechanical grid frame arranged on top of at least a portion of the first touch-sensitive display, the method comprising:
obtaining contextual information pertaining to the at least one software application;
configuring the at least one user-interaction console, based on the contextual information, to establish compatibility between the at least one user-interaction console and the at least one software application;
displaying the first graphical information at the first touch-sensitive display;
enabling, via the at least one user-interaction console, a user to provide the at least one context-based command;
converting the at least one context-based command into a required format that is understandable by the at least one software application; and
transmitting the at least one context-based command having the required format to the at least one software application to control the at least one software application.

In yet another aspect, an embodiment of the present disclosure provides user-interaction console for controlling at least one software application, the user-interaction console comprising:
a plurality of physical user-interaction controllers, wherein a given physical user-interaction controller is associated with at least one context-based command pertaining to the at least one software application;
a first touch-sensitive display that, in operation, displays a first graphical information; and
mechanical grid frame arranged on top of at least a portion of the first touch-sensitive display, wherein the mechanical grid frame defines a plurality of sub-portions in said portion of the first touch-sensitive display.

The present disclosure provides the aforementioned system, the aforementioned method, and the aforementioned user-interaction console for controlling the at least one software application. The system described herein allows the user to conveniently control the at least one software application in a time-efficient manner. In particular, the processor of the system allows the at least one user-interaction console to accurately adapt to a given software application that is to be controlled. Moreover, the system described herein is simple, user-friendly and cost-efficient. The method described herein is simple and easy to implement. The user-interaction console is ergonomically designed for the user's comfort and convenience. The user-interaction console is a hands-on accessory that provides the user with a considerable degree of context-based control at the user's disposal. Moreover, provision of graphical information at touch-sensitive display(s) of the user-interaction console considerably enhances the user's experience of using the user-interaction console. The mechanical grid frame, in combination with its corresponding touch-sensitive display, provides the user with a physical keyboard-like usage experience. As a result, when the user uses the user-interaction console over a period of time, he/she develops muscle memory of such usage.

Pursuant to embodiments of the present disclosure, the system and the user-interaction console enable controlling of the at least one software application, wherein a user provides context-based commands to control the at least one software application via the user-interaction console. Herein, the term “software application” refers to a software utility tool designed to perform pre-determined and coordinated functions, tasks, or activities based on commands provided by the user. The software application provides a given set of services (for example, such as, image editing, video editing, audio editing and the like) for the benefit of the user. Examples of the at least one software application includes, but are not limited to, an image editing tool, a video editing tool, an audio editing tool and an automation system. It will be appreciated that the commands provided by the user are based on a context of the at least one software application.

The system for controlling the at least one software application comprises the at least one user-interaction console. Herein, the term “user-interaction console” refers to a hardware input device for enabling the user to provide context-based commands for the at least one software application. It will be appreciated that the user-interaction console provides a physical device to the user for providing context-based commands to the at least one software application. Beneficially, such physical device provides a more user-friendly medium of providing context-based commands in comparison to using a computer mouse and a display associated with a computing device executing the at least one software application.

The user-interaction console comprises the plurality of physical user-interaction controllers, wherein a given physical user-interaction controller is associated with at least one context-based command pertaining to the at least one software application. Notably, each of the plurality of physical user-interaction controllers is associated with at least one context-based command, wherein the user provides such context-based commands by controlling the corresponding physical user-interaction controllers. Herein, the plurality of physical user-interaction controllers refer to controllers that can receive mechanical physical gestures such as pressings, turns, sliding motions, toggles and the like from the user, as a context-based command. Examples of physical user-interaction controllers include, but are not limited to, toggle switches, press buttons, trackballs, linear and circular sliders, rotary dials, analogue sticks. In an example, the physical user-interaction controller may be a rotary dial associated with adjusting sharpness of an image in the at least one software application. In such example, a clockwise rotation of the rotary dial may increase the sharpness of the image, whereas a counter-clockwise rotation of the rotary dial may decrease the sharpness of the image in the at least one software application. Herein, the at least one context-based command is an instruction executed upon change in state (for example, such as, ON/OFF, up/down and so forth) of the given physical user-interaction controller. The context-based command relates to a function pertaining to the at least one software application. In an example, the software application may be an image editing tool, a context-based command may be increasing contrast in a given image in the image editing tool.

Optionally, the plurality of physical user-interaction controllers comprise at least one button and at least one dial. Notably, each of the at least one button and the at least one dial are associated with the given context-based command pertaining to the at least one software application. In an example, the at least one button may be pressed to activate a mode of the at least one software application. In another example, the at least one dial may be used to adjust value of a parameter associated with the at least one software application, wherein for example, such parameter may be, contrast of an image. Herein, the at least one button may be a toggle button, wherein such at least one button toggles between an ‘on’ state and an ‘off’ state. Alternatively, the at least one button may be a press button, wherein a press provided by the user to the press button provides a context-based command to the software application. Similarly, the at least one dial may be a rotary dial (such as a volume control dial in an audio player) or a circular slider dial (such as a scroll wheel in a computer mouse).

The user-interaction console further comprises the first touch-sensitive display that, in operation, displays the first graphical information. The first touch-sensitive display acts as an interface between the user and the user-interaction console, wherein the user provides a touch input to the interface for providing a context-based command. The first touch-sensitive display, in operation, displays first graphical information and subsequently, enable the user to provide touch input for controlling functioning of the at least one software application. Additionally, the first touch-sensitive display is a multi-touch touch-sensitive display. Such touch-sensitive displays are well known in the art. Beneficially, implementation of the first touch-sensitive display on the user-interaction console provides the user with an ability to customize and personalize the user-interaction console according to the at least one software application and preferences thereof.

Optionally, the first graphical information is arranged to indicate at least one of:
the at least one context-based command associated with the plurality of physical user-interaction controllers;
at least one icon, wherein the at least one icon is associated with at least one workspace page of the at least one software application;
a digital media associated with the at least one software application;
a virtual keyboard.

Optionally, in an instance, the first graphical information is arranged to indicate the at least one context-based command associated with the plurality of physical user-interaction controllers. Herein, the context-based commands associated with the plurality of physical user-interaction controllers are provided as an index (such as a tabulated list detailing context-based command associated with corresponding physical user-interaction controller) on the first touch-sensitive display. Notably, such index may assist user in providing inputs using the plurality of physical user-interaction controllers. Furthermore, the at least one icon refers to a user-interface element providing a specific functionality in the at least one workspace page of the at least one software application. It will be appreciated that a given software application, such as an image editing software application comprises workspace pages for editing of the images. Therefore, the at least one icon is provided as the first graphical information to enable the user to execute the specific functionality associated with the icon by providing a touch-input thereto, wherein such specific functionality (such as a crop function, a bokeh effect) is associated with the workspace page of the image editing software application.

Optionally, in an instance, the first graphical information is arranged to indicate a digital media associated with the at least one software application. Such digital media include at least one of: an image, a video, an electronic document, a webpage associated with the at least one software application. In an example, the digital media may be an electronic document comprising a user manual detailing instructions for use of the software application associated there-with. In another example, the software application may be an image editing software application, wherein a given image is edited therein. Consequently, the given image or a portion thereof may be provided as the first graphical information. Moreover, the first graphical information is arranged to indicate the virtual keyboard (such as a virtual QWERTY keyboard), wherein the first touch-sensitive display enables the user to provide touch-input to perform functions such as entering alphanumeric values into the at least one software application. Beneficially, providing such virtual keyboard on the first touch-sensitive display eliminates the need of a physical keyboard to provide alphanumeric inputs to the at least one software application.

In an embodiment, the user-interaction console further comprises a second touch-sensitive display that, in operation, displays a second graphical information. In addition to the first touch-sensitive display, the user-interaction console comprises the second touch-sensitive display for providing the user another interface for receiving information, and providing context-based commands as touch-inputs.

Optionally, the second graphical information is arranged to indicate at least one of:
a list of parameters pertaining to the at least one software application;
a list of the plurality of physical user-interaction controllers;
information pertaining to the at least one software application;
a widget or an application executed by the processor.

Optionally, in an instance, the second graphical information indicates the list of parameters enabling the user to adjust, values of parameters included in the list of parameters using the interface of the second touch-sensitive display. Furthermore, the second graphical information indicates the list of the plurality of physical user-interaction controllers, wherein the user views the second graphical information to determine the at least one context-based command associated with the given physical user-interaction controller in the list of the plurality of physical user-interaction controllers. Beneficially, such list of the plurality of physical user-interaction controllers allows the user to easily determine a function associated with the given physical user-interaction controller.

Optionally, in an instance, the second graphical information indicates information pertaining to the at least one software application. In an example, the information pertaining to the at least one software application includes license details, security information, software version details and the like, of the at least one software application. Moreover, the second graphical information indicates a widget or an application executed by the processor. In particular, the widget refers to a simplified software application or a simplified version of a software application that can provide quick access to a given type of data. Examples of the widget include, but are not limited to, a clock, a calendar, a timer, a memo. Notably, the first graphical information and/or the second graphical information may be unrelated to the software application.

Optionally, the second graphical information is arranged to indicate a rotary dial. Herein, providing a touch-input in a rotation motion to the interface (of the second touch-sensitive display) rendering the rotary dial, adjusts values of one or more parameters associated with the at least one software application or one or more parameters associated with the workspace page of the software application.

The user-interaction console further comprises the mechanical grid frame arranged on top of at least the portion of the first touch-sensitive display, wherein the mechanical grid frame defines the plurality of sub-portions in said portion of the first touch-sensitive display. Notably, the mechanical grid frame provides a physical structure to at least the portion of the first touch-sensitive display that it is arranged on. Furthermore, the mechanical grid frame creates a grid-like structure on at least the portion of the first touch-sensitive display. Herein, each cell in the grid-like structure represents an area, wherein the touch-input to that area provides a specific context-based command to the at least one software application. It will be appreciated that the user may have difficulty in memorizing the areas of a touch-sensitive display that correspond to specific context-based commands. Such difficulty may be further experienced when the user is not directly looking at the touch-sensitive display. Beneficially, the physical structure provided by the mechanical grid frame provides the user with a sense of familiarity with respect to identifying the areas of the first touch-sensitive display that are to be used to input a given context-based command. As an example the mechanical grid frame structure can be made from a material such as polymer. Grid lines making up the mechanical grid frame might be for example 0.5-3.0 mm wide and have thickness of 0.1 to 1.0 mm. In deed the grid provides touch feeling for a user when the user is moving finger or hand in top of the first touch-sensitive display.

Optionally, the mechanical grid frame comprises a plurality of equisized grid sections. The plurality of equisized grid sections divide at least the portion of the first touch-sensitive display into the plurality of equisized sub-portions. In an example, each of the sub-portions includes an icon pertaining to the at least one software application. In another example, the plurality of equisized grid sections together display an image pertaining to the at least one software application.

Optionally, the mechanical grid frame comprises a plurality of unequally-sized grid sections. The plurality of unequally-sized grid sections divide at least the portion of the first touch-sensitive display into the plurality of unequally sized sub-portions. Notably, size of each of the grid sections is determined based on the first graphical information displayed on the first touch-sensitive display. Optionally, the size of each of the grid section is customizable by the user according to the first graphical information.

Optionally, the mechanical grid frame is detachably arranged on the first touch-sensitive display. Notably, the mechanical grid frame can be detached from the first touch-sensitive display to provide the user with an uninterrupted view and access of the first touch-sensitive display. Beneficially, the detachable arrangement of the mechanical grid frame provides the user with an option to customize the first touch-sensitive display according to preferences thereof.

Optionally, the mechanical grid frame and the first touch-sensitive display are integral. The integral arrangement of the mechanical grid frame provides a robust structure to the first touch-sensitive display. In addition, the fixed arrangement of the mechanical grid frame secures the first touch-screen display against various physical wear and tear caused by a rough use thereof.

It will be appreciated that the user-interaction console comprises a plurality of circuits coupled with at least one microcontroller for converting the inputs, provided by the user using the plurality of physical user-interaction controllers, into a machine-readable format. In particular, the plurality of circuits detects the mechanical physical gestures provided by the user and subsequently, transmits a corresponding signal (such as, a current) to the at least one microcontroller.

Furthermore, the system for controlling the at least one software application comprising the aforementioned user-interaction console, further comprises the processor. Herein, the term “processor” refers to a computational element that is operable to respond to and process instructions that drive the system controlling the at least one software application. Optionally, the processor includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processor includes elements, to enable wired and/or wireless coupling of the processor with devices such as the at least one user-interaction console and the computing device.

In an implementation of the present disclosure, the processor is associated with the computing device. Pursuant to embodiments of the present disclosure, the computing device is operable to execute the at least one software application thereon. Herein, the computing device refers to an electronic device associated with (or used by) the user that is capable of enabling the user to perform specific tasks associated with the aforementioned system. Furthermore, the computing device is intended to be broadly interpreted to include any electronic device that may be used for voice and/or data communication over a wired or a wireless communication network. Examples of computing device include, but are not limited to, cellular phones, personal digital assistants (PDAs), handheld devices, wireless modems, laptop computers, personal computers, game consoles, home automation systems, IoT control systems, etc. Additionally, the computing device includes a casing, a memory, a processing arrangement, a network interface card, a microphone, a speaker, a keypad, and a display.

In an embodiment, the processor is associated with the computing device using a local wired connection. In particular, the processor is located at a location of the computing device, wherein connection between the computing device and the processor, is implemented using a wired network. Optionally, the processor refers to the processing arrangement of the computing device.

In another embodiment, the processor is associated with the computing device using a remote wireless connection. In particular, the processor is located at a different location than the computing device, wherein the connection between the computing device and the processor is implemented using a wireless network. In an example, the connection between the computing device and the processor is implemented using a cloud-based connection. Examples of the wireless networks include, but are not limited to, Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks and Worldwide Interoperability for Microwave Access (WiMAX) networks.

The processor is coupled in communication to the at least one user-interaction console. Notably, the processor is coupled in communication to the at least one user-interaction console by way of a communication network, wherein the communication network is an arrangement of interconnected programmable and/or non-programmable components. The communication network may provide wireless coupling and/or wired communication coupling. In an example, the user-interaction console may include a connecting interface (such as a Universal Serial Bus port) that is plugged into the processor or the computing device associated with the processor. In another example, the user-interaction console may be coupled in communication with the processor using a wireless connection such as a Bluetooth or a Wi-Fi® connection. Examples of the communication network include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G), fourth generation (4G) or fifth generation (5G) telecommunication networks, and Worldwide Interoperability for Microwave Access (WiMAX) networks.

The processor is configured to execute the service software application. Herein, the term “service software application” refers to a software program comprising a set of instructions that, when executed by the processor, performs a plurality of operations for controlling the at least one software application. The service software application functions as an interface between the at least one user-interaction console and the at least one software application, wherein the service software application assists the user in providing context-based commands using the user-interaction console, and converts such context-based commands into a required format that is understandable by the at least one software application.

The processor is configured to execute the service software application to obtain contextual information pertaining to the at least one software application. Herein, the at least one software application refers to the software application that the user requires to control using the user-interaction console. As aforementioned, the user-interaction console is coupled in communication with the processor, wherein the processor is associated with the computing device executing the at least one software application. Notably, the user, using the computing device, launches such at least one software application and selects the user-interaction console as an input device. Subsequently, the service software application obtains contextual information pertaining to the at least one software application. Herein, the contextual information refers to characteristics and features of the software application such as type of the software application, operations performed by the software application, specific tools available in the software application and the like. For example, contextual information pertaining to a given software application may include information that the software application is a video editing tool performing operations such as adjustments related to frames in the video, speed of the video and the like.

It will be appreciated that the user-interaction console, specifically the plurality of physical user-interaction controllers and the first touch-sensitive display, are customized and exhibit a variation in functionality based on the software application being controlled thereby. In other words, a given physical user-interaction controller may perform varying functions for varying software applications. Similarly, the first graphical information displayed on the first touch-sensitive display may change based on the software application. Therefore, contextual information pertaining to the at least one software application is obtained to enable customized operation of the user-interaction console with respect to the at least one software application.

The service software application further configures the at least one user-interaction console, based on the contextual information, to establish compatibility between the at least one user-interaction console and the at least one software application. Notably, based on the contextual information, the service software application designates the operation that each of the plurality of physical user-interaction controller is to perform in the software application upon receiving a context-based command thereon from the user. Similarly, the first graphical information displayed on the first touch-sensitive display is determined based on the contextual information.

Optionally, the processor is communicably coupled with a database, wherein the database stores set of instructions required to establish compatibility between the at least one user-interaction console and the at least one software application. In particular, the database stores sets of instructions required to establish compatibility between the at least one user-interaction console and a plurality of software applications. Therefore, the service software application retrieves the set of instructions for the at least one software application that the user requires to control with the at least one user-interaction console and establishes compatibility therewith.

Optionally, the processor is configured to execute the service software application to provide the user with a user interface to enable the user to manually configure the at least one user-interaction console, based on the contextual information. Notably, the user may wish to configure the at least one user-interaction console based on personal preferences thereof. Specifically, the user designates specific operations to one or more of the plurality of physical user-interaction controllers according to his/her personal preferences. It will be appreciated that the user interface is rendered on the computing device associated with the processor, and the user employs the computing device for the manual configuration. In an implementation, the service software application may present in the user-interface, a digital mock-up of the user-interaction console, wherein the digital mock-up comprises interface elements representing at least each of the plurality of physical user-interaction controllers, and may optionally, comprise interface elements representing the first touch-sensitive display. Subsequently, the user selects the interface elements corresponding to the physical user-interaction controllers that he/she wishes to configure. Thereafter, the user designates the operation of physical user-interaction controller represented by the selected interface element. Additionally, the service software application, based on the contextual information, may also provide the user with a list of possible operations that may be designated for selected physical user-interaction controller. Similarly, the user may configure the first graphical information to be displayed on the first touch-sensitive display.

In an embodiment, the user-interaction console comprises an audio-based user-interaction module configured to obtain an audio input from the user. Herein, the audio-based user-interaction module refers to a set of programmable hardware components that allows the user to send audio signals (such as the audio input) to a processor for processing, recording, or carrying out commands. Subsequently, the processor analyses the audio input provided by the user to perform an operation based thereupon. In an example, the audio-based user-interaction module is a microphone operable to receive audio signals from the user and convert said audio signals into electrical signals prior to communicating the electrical signals to the processor. Optionally, the user-interaction console may comprise a microphone button operable to activate the audio-based user-interaction module, wherein the audio-based user-interaction module initiates recording of audio thereby, when the microphone button is pressed by the user.

In another embodiment, the processor comprises the audio-based user-interaction module.

In yet another embodiment, the computing device associated with the processor comprises the audio-based user-interaction module.

According to an embodiment, the processor is configured to execute the service software application to:
enable, via the audio-based user-interaction module, the user to provide a configuration audio input; and
configure the at least one user-interaction console, based on the configuration audio input.

Optionally, in this regard, the service software application enables the user to manually configure the user-interaction console by providing one or more audio inputs to the audio-based user-interaction console. Notably, the service software application enables the user to provide the configuration audio input via the audio-based user-interaction module. In an implementation, the user selects the physical user-interaction controller, that he/she wishes to manually configure, using the user-interface provided by the service software application, as mentioned herein earlier. Subsequently, the user provides the configuration audio input, detailing the operation that the user wishes to designate to the selected physical user-interaction controller.

The service software application displays the first graphical information at the first touch-sensitive display.

Optionally, the processor is configured to execute the service software application to display the second graphical information at the second touch-sensitive display.

The service software application enables, via the at least one user-interaction console, the user to provide the at least one context-based command. The user provides the at least one context-based command using at least one of: the plurality of physical user-interaction controllers, the first touch-sensitive display, and optionally, the second touch-sensitive display. Specifically, the user employs mechanical physical gestures as inputs to provide the context-based commands using the plurality of physical user-interaction controllers. Alternatively, the user employs touch gestures as inputs to provide the context-based commands using the first-touch sensitive display and/or the second touch-sensitive display.

The service software application converts the at least one context-based command into a required format that is understandable by the at least one software application. Notably, the at least one context-based command provided by the user via the user-interaction console is in form of either the mechanical physical gestures (such as a pressing, sliding motion, toggles) from the plurality of physical user-interaction controllers or the touch input from the first touch-sensitive display or the second touch-sensitive display. Therefore, such at least one context-based command is converted into the required format by the service software application. As aforementioned, each of the plurality of physical user-interaction controllers transmits a corresponding signal upon receiving the context-based command thereon. Similarly, the first touch-sensitive display and the second touch-sensitive display transmit signals based on the area thereof receiving the touch input. Therefore, such signals are analysed and converted into the required format understandable by the at least one software application.

In an embodiment, the service software application comprises at least one context-based software plugin, the processor being configured to execute the at least one context-based software plugin to:
receive the at least one context-based command having a first format; and
convert the at least one context-based command having the first format into the at least one context-based command having the required format.

Optionally, in this regard, the at least one context-based software plugin refers to a software component of the service software application operable to support conversion of the at least one context-based command into the required format. It will be appreciated that for different software applications, the format of at least one context-based command that is understandable thereby may be different. Therefore, the service software application comprises at least one context-based software plugin specific to the at least one software application. In an instance, when the system controls a plurality of software applications, the service software application comprises a plurality of context-based software plugins, wherein a given context-based software plugin corresponds to a given software application. Herein, the at least one context-based software plugin receives the at least one context-based command having the first format, wherein the service software application converts a hardware format received from the at least one user-interaction console (for example, such as the mechanical physical gestures or the touch input, as explained herein above) into the first format. In particular, the first format refers to a format of the at least one context-based command that is understandable by the software plugin. Subsequently, the at least context-based software plugin converts the at least one context-based command having the first format into the at least one context-based command having the required format. It will be appreciated that in an instance when the service software application comprises a plurality of context-based software plugins for a plurality of software applications, the service software application provides the context-based commands to the plurality of context-based software plugins in a common first format. Thereafter, a given context-based software plugin (of the plurality of context-based software plugins) converts the context-based commands into the required format that is understandable by the corresponding given software application.

According to an embodiment, at least one of the user-interaction console or the processor further comprises an audio-based user-interaction module, and wherein the processor is configured to execute the service software application to:
enable, via the audio-based user-interaction module, the user to provide an audio input pertaining to the at least one context-based command;
convert the audio input into the required format; and
transmit the audio input having the required format to the at least one software application to control the at least one software application.

Optionally, in this regard, the service software application enables the user to provide at least one context-based command as the audio input pertaining to the at least one context-based command using the audio-based user-interaction module. In other words, the user provides the at least one context-based command as the audio input pertaining to the at least one context-based command using the audio-based user-interaction module. Subsequently, the service software application converts the audio input into the required format that is understandable by the at least one software application. Thereafter, the service software application transmits the audio input having the required format to the at least one software application to control the at least one software application.

The service software application transmits the at least one context-based command having the required format to the at least one software application to control the at least one software application. As aforementioned, the computing device communicably coupled with the processor executes the at least one software application thereon. Therefore, the service software application, executed by the processor, transmits the at least one context-based command to the computing device for controlling the at least one software application. Subsequently, the computing device provides the at least one context-based command to the at least one software application, wherein the at least one software application performs the operation that is related to the at least one context-based command.

The present disclosure also relates to the method as described above. Various embodiments and variants disclosed above apply mutatis mutandis to the method.

### DETAILED DESCRIPTION OF THE DRAWINGS

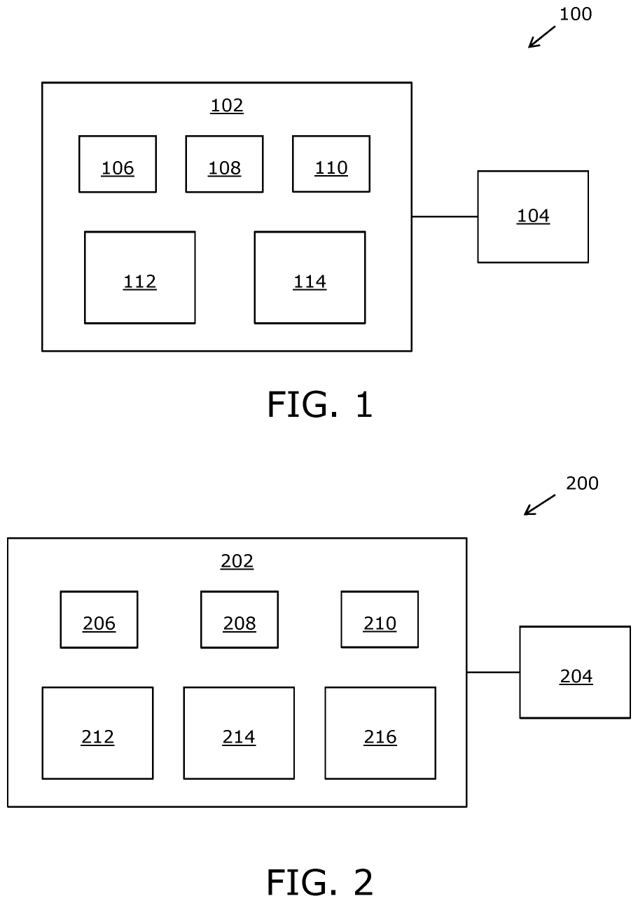

Referring to FIG. 1, illustrated is a block diagram of architecture of a system 100 for controlling at least one software application, in accordance with an embodiment of the present disclosure. The system 100 comprises one user-interaction console 102 and a processor 104.

The user-interaction console 102 comprises a plurality of physical user-interaction controllers (depicted as physical user-interaction controllers 106, 108 and 110), a first touch-sensitive display 112 and a mechanical grid frame 114. Furthermore, the processor 104 is coupled in communication with the user-interaction console 102, wherein the processor 104 is configured to execute a service software application to carry out the invention as described above.

Referring to FIG. 2, illustrated is a system 200 for controlling at least one software application, in accordance with another embodiment of the present disclosure. The system 200 comprises at least one user-interaction console 202, and a processor 204 coupled in communication with the user-interaction console 202. The user-interaction console 202 comprises a plurality of physical user-interaction controllers 206, 208 and 210, a first touch-sensitive display 212 and a second touch-sensitive display 214, and a mechanical grid frame 216.

It may be understood by a person skilled in the art that FIG. 2 includes simplified architecture of the system 200 for sake of clarity, which should not unduly limit the scope of the claims herein. The person skilled in the art will recognize many variations, alternatives, and modifications of embodiments of the present disclosure.

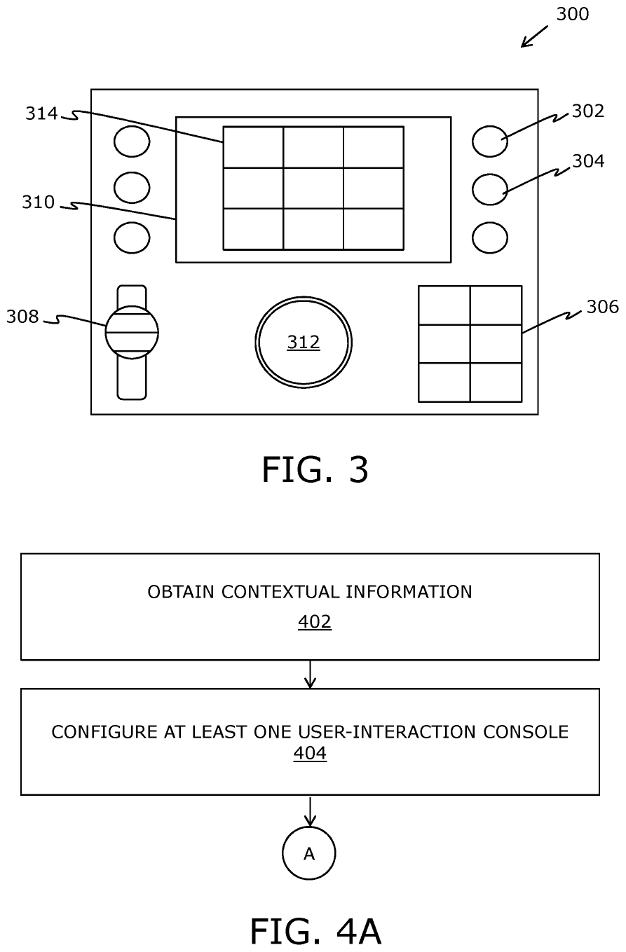

Referring to FIG. 3, illustrated is a schematic diagram of a user-interaction console 300 for controlling at least one software application, in accordance with an embodiment of the present disclosure. The user-interaction console 300 comprises a plurality of physical user-interaction controllers 302, 304, 306 and 308. Herein, the user-interaction controllers 302 and 304 are analogue sticks, the controller 306 is a set of buttons and the controller 308 is a linear slider. The user-interaction console 300 also comprises a first touch-sensitive display 310 and a second touch-sensitive display 312 as well as a mechanical grid frame 314 arranged on top of at least a portion of the first touch-sensitive display 310, wherein the mechanical grid frame 314 defines a plurality of sub-portions in said portion of the first touch-sensitive display 310.

It may be understood by a person skilled in the art that FIG. 3 includes simplified architecture of the user-interaction console 300 for sake of clarity, which should not unduly limit the scope of the claims herein. The person skilled in the art will recognize many variations, alternatives, and modifications of embodiments of the present disclosure.

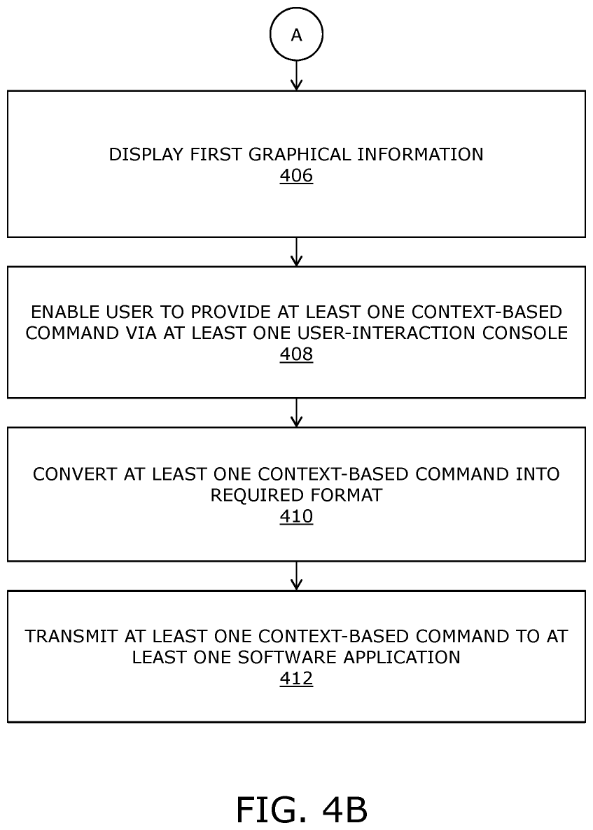

Referring to FIGS. 4A and 4B, illustrated is a flow chart depicting steps of a method 400 for controlling at least one software application via at least one user-interaction console, in accordance with an embodiment of the present disclosure. The method is depicted as a collection of steps in a logical flow diagram, which represents a sequence of steps that can be implemented in hardware, software, or a combination thereof, for example as aforementioned. At step 402, contextual information pertaining to the at least one software application is obtained. At step 404, the at least one user-interaction console is configured based on the contextual information, to establish compatibility between the at least one user-interaction console and the at least one software application. At step 406, the first graphical information is displayed at the first touch-sensitive display. At step 408, a user is enabled, via the at least one user-interaction console, to provide the at least one context-based command. At step 410, the at least one context-based command is converted into a required format that is understandable by the at least one software application. At step 412, the at least one context-based command having the required format is transmitted to the at least one software application to control the at least one software application.

The steps 402, 404, 406, 408, 410 and 412 are only illustrative and other alternatives can also be provided where one or more steps are added, one or more steps are removed, or one or more steps are provided in a different sequence without departing from the scope of the claims herein.

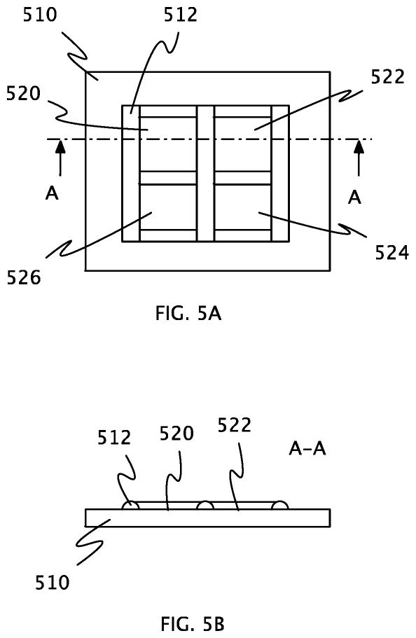

FIG. 5A (seen from above) and FIG. 5B (cross section A-A of FIG. 5A) are an illustration of a detail of a user-interaction console. A mechanical grid frame 512 is arranged in top of a first touch-sensitive display 510. The mechanical grid frame 512 provides physical touch feeling for a user as the user moves finger along the first touch sensitive display 510. The mechanical grid frame 512 divides the first touch sensitive display 510 to a sub-portions 520, 522, 524 and 526. The mechanical grid frame in practice protrudes from a surface of the touch-sensitive display 510.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for controlling at least one software application, the system comprising:
at least one user-interaction console, the user-interaction console comprising:
a plurality of physical user-interaction controllers, wherein a given physical user-interaction controller is associated with at least one context-based command pertaining to the at least one software application;
a first touch-sensitive display that, in operation, displays a first graphical information; and
a mechanical grid frame arranged on top of at least a portion of the first touch-sensitive display, wherein the mechanical grid frame defines a plurality of sub-portions in said portion of the first touch-sensitive display; and
a processor coupled in communication with the at least one user-interaction console, wherein the processor is configured to execute a service software application to:
obtain contextual information comprising operations performed by the at least one software application;
configure the at least one user-interaction console, based on the contextual information, to designate operations that each physical user-interaction controller performs in the at least one software application upon receiving a context based command from a user;
display the first graphical information at the first touch-sensitive display;
enable, via the at least one user-interaction console, a user to provide the at least one context-based command;
convert the at least one context-based command into a required format that is understandable by the at least one software application; and
transmit the at least one context-based command having the required format to the at least one software application to control the at least one software application.

2. The system of claim 1, wherein the user-interaction console further comprises a second touch-sensitive display that, in operation, displays a second graphical information.

3. The system of claim 2, wherein the processor is configured to execute the service software application to display the second graphical information at the second touch-sensitive display.

4. The system of claim 1 wherein the processor is configured to execute the service software application to provide the user with a user interface to enable the user to manually configure the at least one user-interaction console, based on the contextual information.

5. The system of claim 1, wherein the service software application comprises at least one context-based software plugin, the processor being configured to execute the at least one context-based software plugin to:
receive the at least one context-based command having a first format; and
convert the at least one context-based command having the first format into the at least one context-based command having the required format.

6. The system of claim 1, wherein at least one of the user-interaction console or the processor further comprises an audio-based user-interaction module, and wherein the processor is configured to execute the service software application to:
enable, via the audio-based user-interaction module, the user to provide a configuration audio input; and
configure the at least one user-interaction console, based on the configuration audio input.

7. A method for controlling at least one software application via at least one user-interaction console, the user-interaction console comprising a plurality of physical user-interaction controllers, a first touch-sensitive display, and a mechanical grid frame arranged on top of at least a portion of the first touch-sensitive display, the method comprising:
obtaining contextual information comprising operations performed by the at least one software application;
configuring the at least one user-interaction console, based on the contextual information, to designate operations that each physical user-interaction controller performs in the at least one software application upon receiving a context based command from a user;
displaying a first graphical information at the first touch-sensitive display;
enabling, via the at least one user-interaction console, a user to provide at least one context-based command;
converting the at least one context-based command into a required format that is understandable by the at least one software application; and
transmitting the at least one context-based command having the required format to the at least one software application to control the at least one software application.

8. A user-interaction console for controlling at least one software application, the user-interaction console comprising:
a plurality of physical user-interaction controllers, wherein a given physical user-interaction controller is associated with at least one context-based command pertaining to the at least one software application;
a first touch-sensitive display that, in operation, displays a first graphical information;
a mechanical grid frame arranged on top of at least a portion of the first touch-sensitive display, wherein the mechanical grid frame defines a plurality of sub-portions in said portion of the first touch-sensitive display; and
a processor coupled in communication with the at least one user-interaction console, wherein the processor is configured to execute a service software application to:
obtain contextual information comprising operations performed by the at least one software application;
configure the at least one user-interaction console, based on the contextual information, to designate operations that each physical user-interaction controller performs in the at least one software application upon receiving a context based command from a user.

9. The user-interaction console of claim 8, further comprising a second touch-sensitive display that, in operation, displays a second graphical information.

10. The user-interaction console of claim 8, wherein the mechanical grid frame comprises a plurality of equisized grid sections.

11. The user-interaction console of claim 8, wherein the mechanical grid frame is detachably arranged on the first touch-sensitive display.

12. The user-interaction console of claim 8, wherein the plurality of physical user-interaction controllers comprise at least one button and at least one dial.

13. The user-interaction console of claim 8, further comprising an audio-based user-interaction module configured to obtain an audio input from a user.

14. The user-interaction console of claim 8, wherein the first graphical information is arranged to indicate at least one of:
the at least one context-based command associated with the plurality of physical user-interaction controllers;
at least one icon, wherein the at least one icon is associated with at least one workspace page of the at least one software application;
a digital media associated with the at least one software application;
a virtual keyboard.

15. The user-interaction console of claim 9, wherein the second graphical information is arranged to indicate at least one of:
a list of parameters pertaining to the at least one software application;
a list of the plurality of physical user-interaction controllers;
information pertaining to the at least one software application;
a widget or an application executed by the processor.
